(19) United States
(12) Patent Application Publication
(10) Pub. No.: US 2010/0330531 A1
(43) Pub. Date: Dec. 30, 2010

(54) BRIDGE SUPPORT, A SCREW AND A METHOD

(75) Inventors: Lennart Olsson, Malmo (SE); Anders Lindberg, Ahus (SE); Olof Bange, Hoganas (SE)

Correspondence Address: FISH & RICHARDSON P.C. (BO), P.O. BOX 1022, MINNEAPOLIS, MN, 55440-1022, US

(73) Assignee: STARTPLATTAN 135575, Kallered (SE)

(21) Appl. No.: 12/668,276

(22) PCT Filed: Jul. 9, 2008
(86) PCT No.: PCT/EP08/58916

§ 371 Date: Sep. 14, 2010

(30) Foreign Application Priority Data
Jul. 9, 2007 (SE) 07016504
Sep. 3, 2007 (US) 60969653

(51) Int. Cl. A61C 8/00

(52) U.S. Cl. 433/173

(57) ABSTRACT

A bridge support (1, 60, 90, 140) for arrangement to an implant (2) has a surface abutting (30) the implant (2), and a first compressible sealing (31) integrally made with said surface (30). The bridge support (1, 60, 90, 140) has a through channel (33) ending at said surface and is shaped so that a shoulder (34) is formed inside said channel (33), and has a second compressible sealing (35) integrally made with said shoulder (33). According to a second embodiment the bridge support (1, 60, 90, 140) has external protrusion at an outside (160) integrally made with the bridge support (1, 60, 90, 140). A screw (3, 250) for fastening the bridge support (1, 60, 90, 140) to an implant has a head (230, 252) with an abutment surface (231) and a stem (232, 252), and has a compressible sealing (237) integrally made with said abutment surface (230). The stem (232, 252) has an external longitudinal recess (234) or a longitudinal through hole (251). A method for fastening a bridge support (1, 60, 90, 140) to an implant (2) having a bore has the steps of arranging the bridge support (1, 60, 90, 140) so that a first sealing (31) is abutting the implant (2) and a channel (33) of the bridge support (1, 60, 90, 140) is arranged over the bore; inserting the screw (3, 250) into said channel (33) and into said bore, so that an abutment surface (230) of the screw (3) is abutting the shoulder (34) of the channel (33); and fastening the bridge support (1, 60, 90, 140) by screwing the screw (3, 250) while the sealing (237) of the screw (3, 250) cooperates with the second sealing (35) of the bridge support (1, 60, 90, 140) during compression of each sealing (35, 137), and until the first sealing (31) of the bridge support (1, 60, 90, 140) is compressed against the implant (2). A method for discharging fluid from a bore of an implant provides a longitudinal external recess (234) or a longitudinal through hole (251) of a screw (3, 250).

### TECHNICAL FIELD

The present invention relates to a bridge support for arrangement to a dental implant to support single artificial teeth or dental bridges. The invention also relates to a screw for fastening the bridge support to the implant. In addition, the invention relates to a method for fastening a bridge support to an implant by using a screw. Furthermore, the invention relates to a method for discharging fluid from a bore of an implant.

### BACKGROUND ART

Implants for anchoring single or several artificial teeth forming dental bridges and implant bridges, respectively, have been existing during a couple of decades. Currently, there are more than two thousands implants available on the market, which are produced and delivered by a great number of manufacturers. The implants differ from each other, for example regarding distinguishing construction and design for connecting single artificial teeth or dental bridges.

Before temporarily or permanently anchoring artificial teeth or dental bridges on implants those must be arranged into and accepted by the bone structure of the oral cavity. Immediately after an implant has been positioned in the bone tissue of the oral cavity, a healing abutment is temporary arranged to the implant for the purpose of forming the gingiva for healing up the implant and for preventing soft tissue and bone tissue to grow into the implant, and hence to facilitate the future arrangement of artificial teeth or dental bridges on the implant. When the gingiva has healed up, the healing abutment is removed and a bridge support is mounted to the implant. A temporary bridge support is a mean for forming an impression of a tooth and is utilised to fasten temporary teeth for a short period of time until the artificial teeth or dental bridges are ready to be permanently fixed. Temporary bridge supports are not currently commercial available, instead a piece of metal or a spare part intended for other purposes is used to produce a temporary bridge support at the moment when it is required. Thereafter a permanent bridge support is required for the fastening the artificial teeth or dental bridges. The main problem with the bridge supports of today is inevitable leakage from the oral cavity. Micro organisms are attaching the proteins of the saliva, which will enter between the bridge support and the implant forming a layer of bacteria around the implant resulting in affected bone tissue, infection and gingivitis.

A drawback with currently used permanent bridge supports is that they are adapted to a specific construction of implants requiring a large number of bridge supports having different designs in store. Choosing a bridge support adapted to the implant is essential, since otherwise leakage may occur between the bridge support and the implant, which may jeopardize the healing up of the implant. A poor adaptation could result in that the bridge support becomes loose.

### SUMMARY OF THE INVENTION

An object of the present invention is to eliminate at least one of the drawbacks mentioned above, which is achieved by assigning to the bridge support the characteristics according to claim 1.

According to a first aspect of the invention, there is provided a bridge support for fastening to a dental implant provided with a bore for arrangement of artificial teeth or dental bridges. The bridge support has a surface provided with a first compressible sealing that is integrally made with the surface abutting the implant and is made of the same material as the surface, and has a through channel having a shoulder provided with a second compressible sealing made of the same material as the shoulder. Each sealing has protrusions forming grooves therebetween, which are circular, helical or spiral-shaped. The protrusions are forming an abutment surface that is plane or inclined in relation to the horizontal plane. According to a second embodiment, the bridge support has external protrusions arranged on an outside integrally made with the bridge support and made in the same material as the bridge support, for example a polymer or a metal.

According to a second aspect of the invention, there is provided a screw for fastening a bridge support to a dental implant. The screw has an abutment surface, provided with a compressible sealing integrally made with the screw, and a stem. The stem has one or several portions having notches therebetween, wherein the several portions are separable at the notches, and has an external longitudinal recess. According to an alternate embodiment the recess could be changed to a through hole elongating through the head and further through the stem. The screw is dimensioned in such way that the abutment surface of the screw is abutting the shoulder of the bridge support when correctly arranged into the bridge support and into the bore of the implant. The sealing has protrusions forming grooves therebetween, which are circular, helical or spiral-shaped. The protrusions are forming an abutment surface that is plane or inclined in relation to the horizontal plane.

According to a third aspect of the invention, a method is provided for fastening a bridge support to a dental implant by using a screw. The method has the steps of arranging the bridge support on the implant in such way that the surface of the bridge support provided with the first sealing is abutting the implant, and that the channel of the bridge support is arranged over the bore; inserting the screw into said channel, in such way that the abutment surface of the screw is abutting the shoulder of the channel, and into said bore; and fastening the bridge support to the implant by screwing the screw while the sealing of the screw is cooperating with the second sealing of the bridge support during compression of each sealing, and until the first sealing of the bridge support is compressed against the implant. The compressions of and cooperation between the sealing of the screw and the second sealing of the bridge implant provide a leak proof connection between the bridge support and the screw, and the compression of the first sealing of the bridge support provide a leak proof connection between the bridge support and the implant.

According to a fourth aspect of the invention, a method is provided for discharging fluid from a bore of an implant using the recess along the stem or through hole through the head and stem of the screw.

Further objects, features and advantages of the present invention will appear from the following detailed description, from the attached drawings as well as from the dependent claims.

### BRIEF DESCRIPTION OF THE DRAWINGS

FIG. 1 is an exploded perspective view of a bridge support of a first embodiment that is to be mounted to an implant by a screw,

FIG. 2 is a cross section of the arrangement in FIG. 1 showing the bridge support mounted to the implant,

FIG. 3 shows a cross section of the bridge support of the first embodiment having a sealing with a plane abutment surface,

FIG. 4 shows an enlarged view of section A in FIG. 3,

FIG. 5 shows an enlarged view of section B in FIG. 3,

FIG. 6 shows a bridge support according to a second embodiment,

FIG. 7 shows an enlarged view of section C in FIG. 6,

FIG. 8 shows an enlarged view of section D in FIG. 6,

FIG. 9 shows a bridge support according to a third embodiment,

FIG. 10 shows an enlarged view of section E in FIG. 9,

FIG. 11 shows an enlarged view of section F in FIG. 9,

FIG. 12 shows a view from below of a bridge support with circular arranged protrusions and a circular base portion,

FIG. 13 shows a view from below of a bridge support with circular arranged protrusions and a hexagonal base portion,

FIG. 14 is an exploded perspective view of a bridge support of a fourth embodiment that is to be mounted to an implant by a screw,

FIG. 15 is a cross section of the arrangement in FIG. 14 showing the bridge support mounted to the implant,

FIG. 16 shows the bridge support in FIG. 15 having a plane abutment surface,

FIG. 17 shows an enlarged view of section G in FIG. 16,

FIG. 18 shows an enlarged view of section H in FIG. 16,

FIG. 19 shows a cross section of the bridge support according to the fourth embodiment having a sealing with an inclined abutment surface,

FIG. 20 shows an enlarged view of section I in FIG. 19,

FIG. 21 shows an enlarged view of section J in FIG. 19,

FIG. 22 shows a view from below of the bridge support in FIG. 16 and FIG. 19 with circular arranged protrusions,

FIG. 23 is a schematic side view of a screw having a longitudinal recess,

FIG. 24 shows an enlarged view of section K in FIG. 18,

FIG. 25 is a schematic side view of a screw having a longitudinal through hole, and

FIG. 26 shows an enlarged view of section L in FIG. 25.

Same reference numerals have been used to indicate the same parts in the figures to increase the readability of the description and for the sake of clarity.

### DETAILED DESCRIPTION

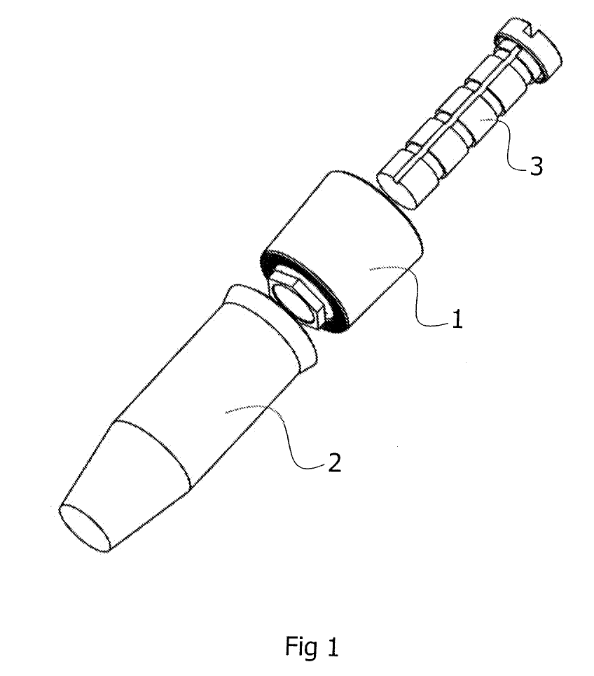

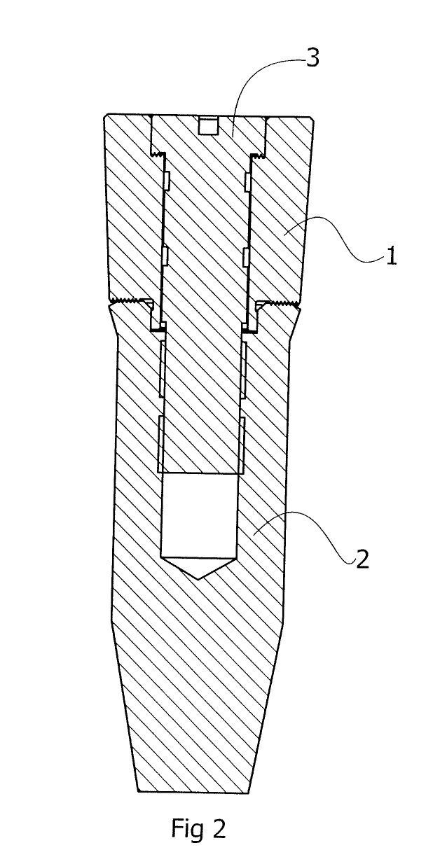

FIG. 1 shows a bridge support 1 according to a first embodiment that is to be arranged on an implant 2 by using a screw 3, and FIG. 2 shows the bridge support 1 in position on the implant fastened by the screw 3.

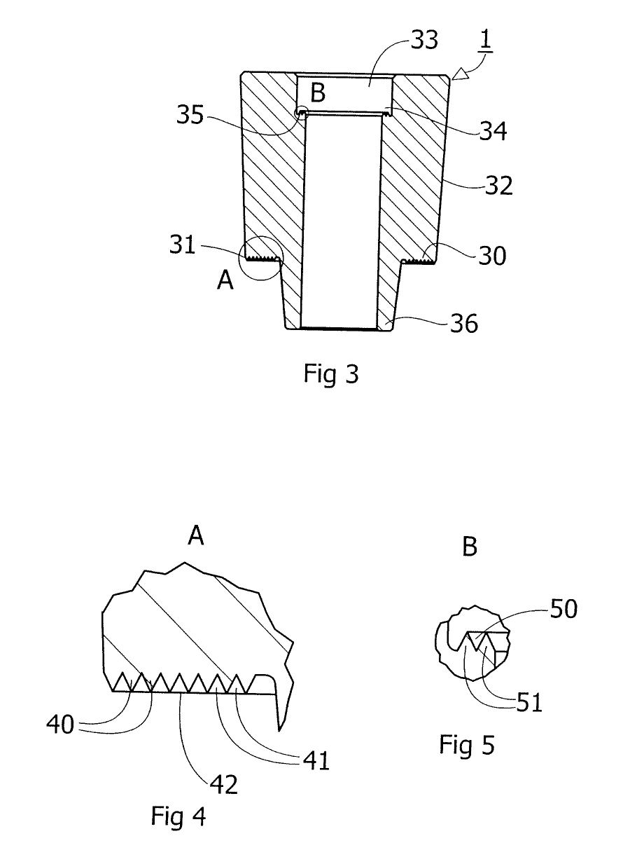

FIG. 3 shows the bridge support 1 having a surface 30 provided with a first compressible sealing 31 integrally made with the surface 30. The bridge support has an outside 32 and has an external cylindrical shape that may be slightly tapered, wherein the outer diameter at an end close to the surface 30 is smaller than an end at the opposite end.

The bridge support 1 has a through channel 33 ending at the surface 30, which has a first diameter forming a first passage and a second diameter forming a second passage. The second diameter is smaller than the first diameter, thus forming a shoulder 34 between the first passage and the second passage. The shoulder 34 is provided with a second compressible sealing 35 integrally made with the shoulder 34. The bridge support 1 has a base portion 36 that is to be connected to the implant 2.

FIG. 6 shows a bridge support 60 of a second embodiment that differs from the bridge support 1 in that an alternate base portion 61 is provided, otherwise the description of the bridge support 60 is similar to the description of the bridge support 1 above.

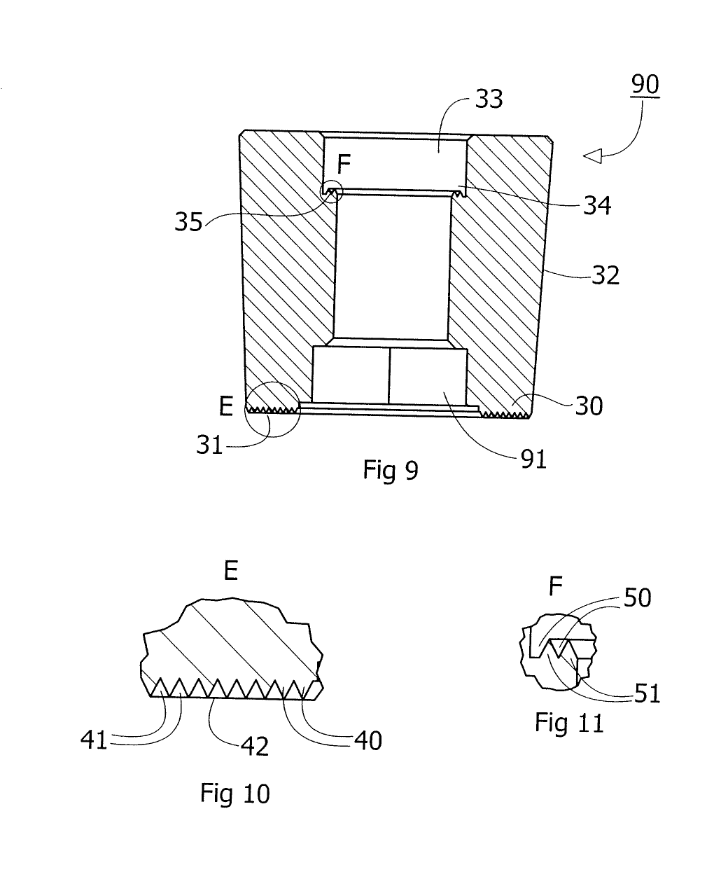

FIG. 9 shows a bridge support 90 according to a third embodiment that differs from the bridge support 1 and 60 in that a base portion 91 is shaped in such way that a third passage is provided, which has a third diameter that is larger than the second diameter. Further embodiments of the bridge support could be possible, which for example have different designs of the base portions to correspond with different designs of implants, to which the bridge support is to be fasten.

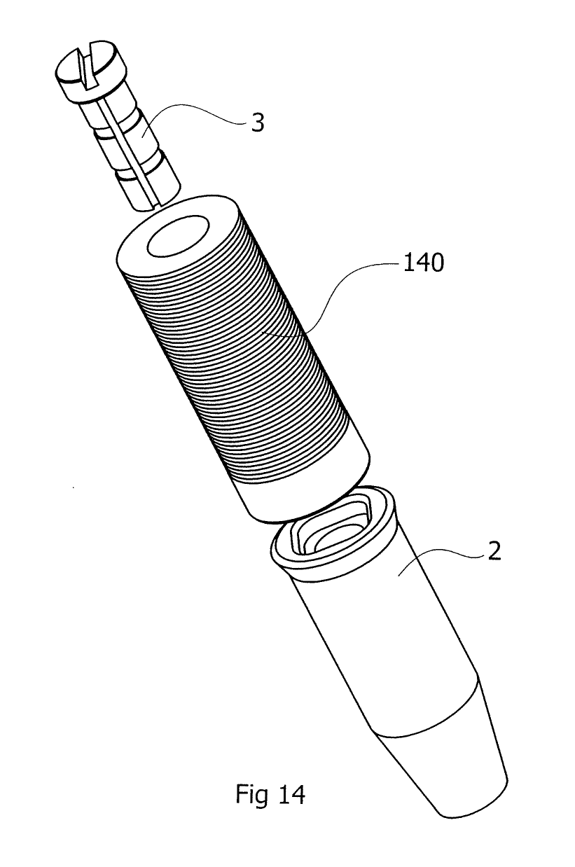

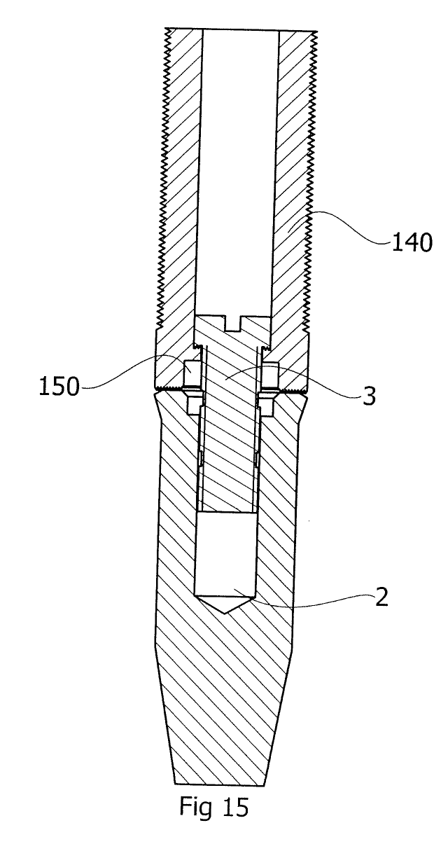

FIG. 14 shows a bridge support 140 according to a fourth embodiment that is to be arranged on an implant 2 by using a screw 3, and FIG. 15 shows the bridge support 140 in position on the implant fastened by the screw 3.

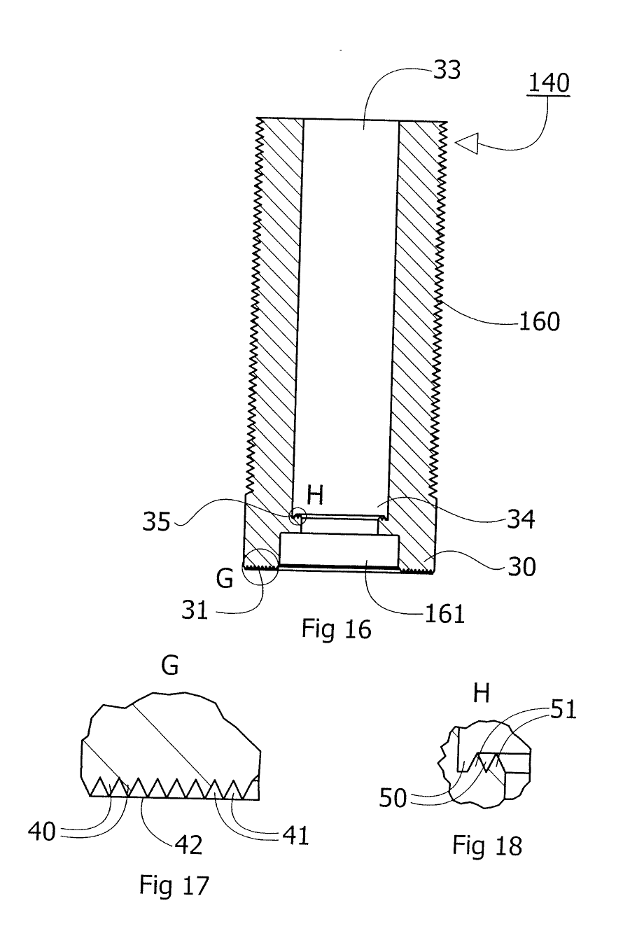

FIG. 16 shows the bridge support 140 having a surface 30 provided with a first compressible sealing 31 integrally made with the surface 30. The bridge support has an external cylindrical shape and has an outside 160 that is provided with protrusions integrally made with the bridge support 140 and made in the same material as the bridge support. The protrusions are shown symmetrically arranged around the outside 160. In an alternate embodiment the external shape could be slightly tapered, and/or the protrusions could be arranged along the outside elongating from one end at the surface 30 to the opposite end. The protrusions of the outside will facilitate when an impression of a tooth or of several teeth need to be done, or when a tooth or several teeth is/are arranged temporarily on the implant.

The bridge support 140 has a through channel 33 ending at the surface 30, which has a first diameter forming a first passage, a second diameter forming a second passage, and a third passage forming a third passage. The second diameter is smaller than the first diameter and the third diameter, thus forming a shoulder 34 between the first passage and the second passage. The shoulder 34 is provided with a second compressible sealing 35 integrally made with the shoulder 34.

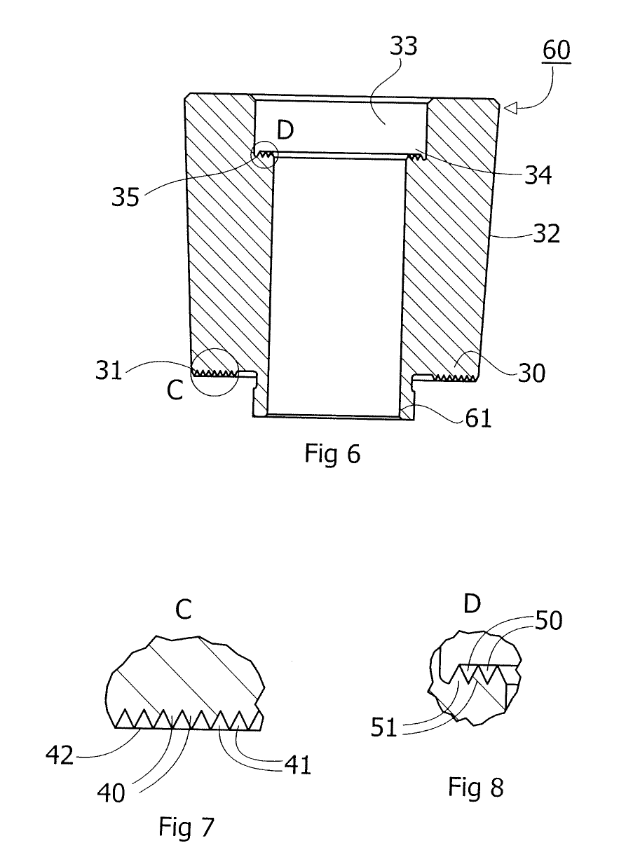

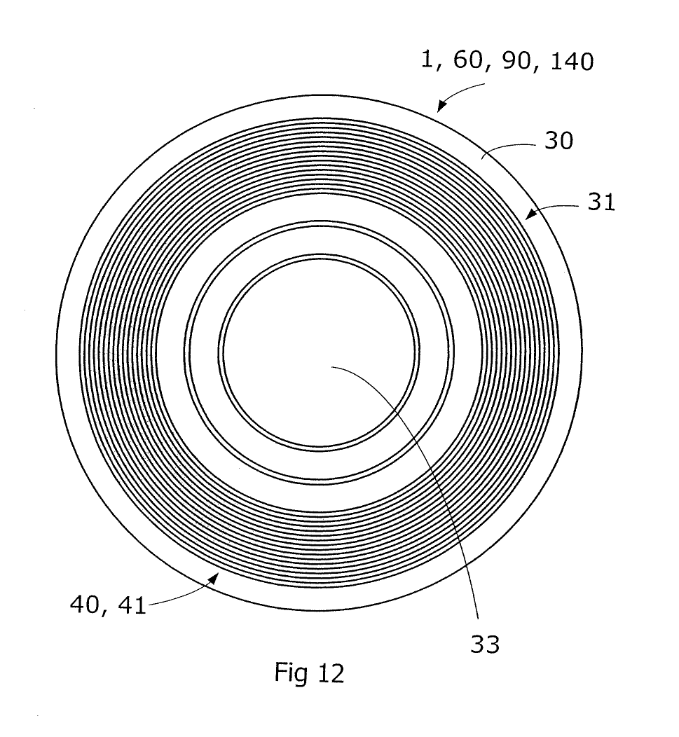

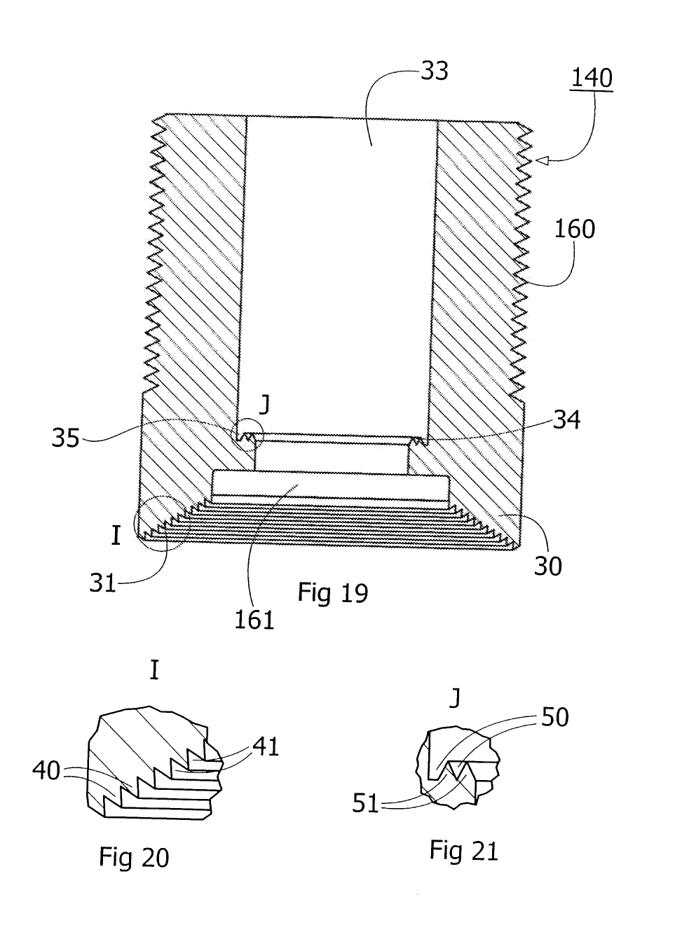

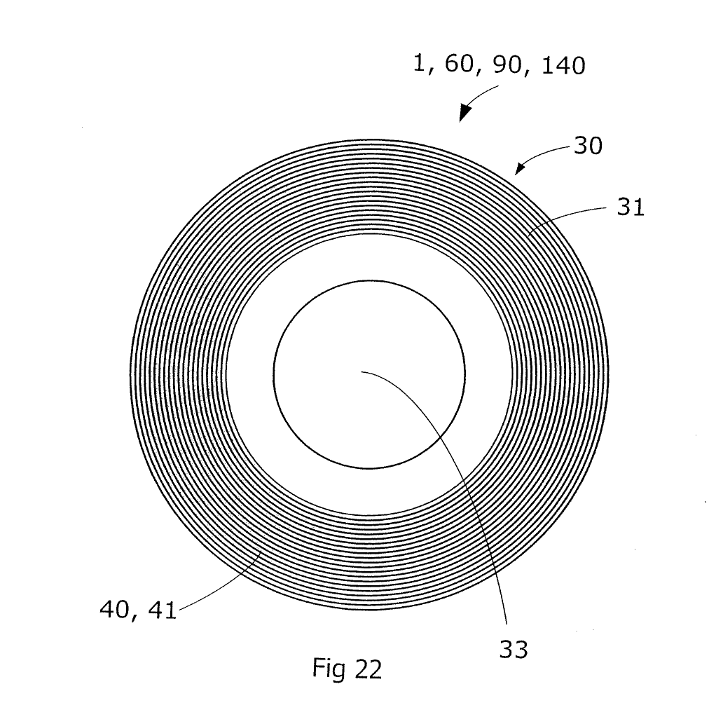

FIGS. 4, 7, 10, 17 and FIGS. 5, 8, 11, 18 show in enlarged scale that the first compressible sealing 31 and the second compressible sealing 35 have protrusions 40, 50 forming grooves 41, 51 therebetween. The protrusions of the first sealing 31 are forming an abutment surface 42 that is plane and straight in relation to the horizontal plane. FIG. 19 and in enlarged scale in FIG. 20 show that the abutment surface 42 could be inclined, which offers flexibility for mounting. In an alternate embodiment the abutment surface could be inwardly or outwardly rounded or tapered.

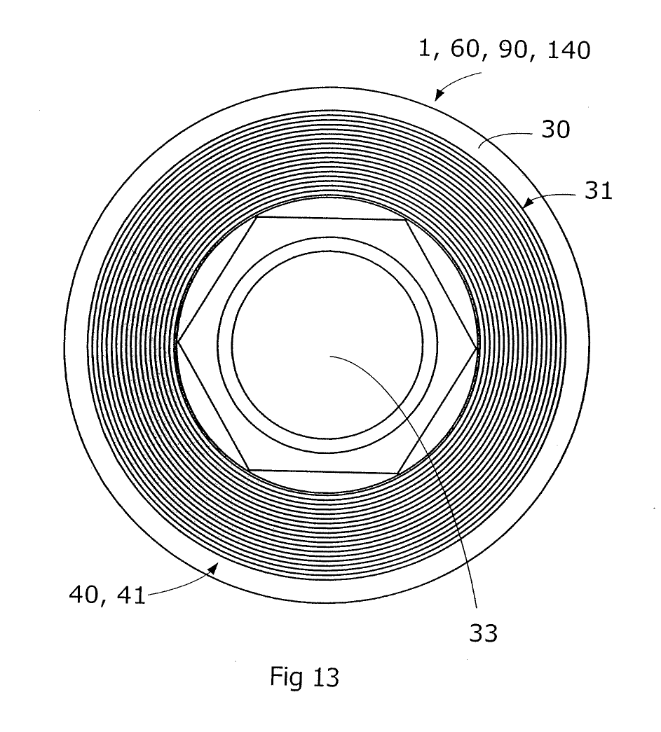

The protrusions 40 and the grooves 41 of the first sealing 31 are circular, helical or spiral-shaped and are symmetrically arranged, as shown in FIG. 12, 13 and FIG. 22. The protrusions 50 and the grooves 51 of the second sealing 35 are circular, helical or spiral-shaped, and are symmetrically arranged at the shoulder 34.

The cross sections of the protrusions 40, 50 of each sealing 31, 35 may be of any shape, such as triangular, triangular having a rounded or truncated cone, semi circular, semi elliptical, or square. The protrusions of each sealing are compressible and are deformed when a force is applied. The function of each sealing is explained below.

The first sealing 31 and the second sealing 35 is integrally made with the bridge support 1, 60, 90, 140 and is made of the same material as the bridge support 1, 60, 90, 140, for example a metal, such as titan, a polymeric material or a ceramic material. In an alternate embodiment, for example when choosing a different material, the protrusions are compressible but could be resilient.

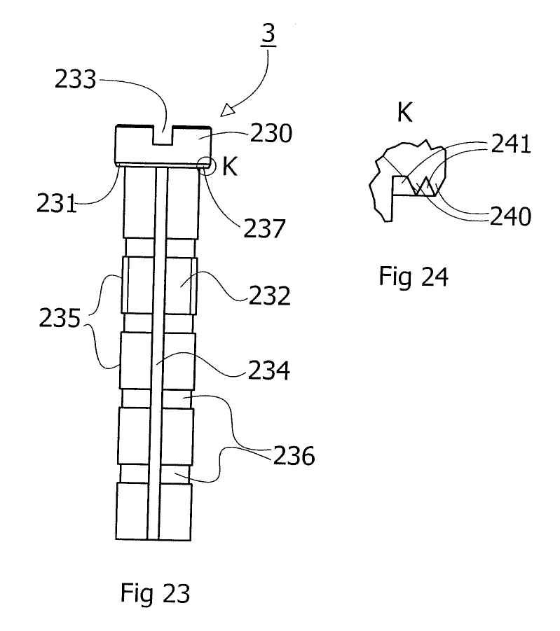

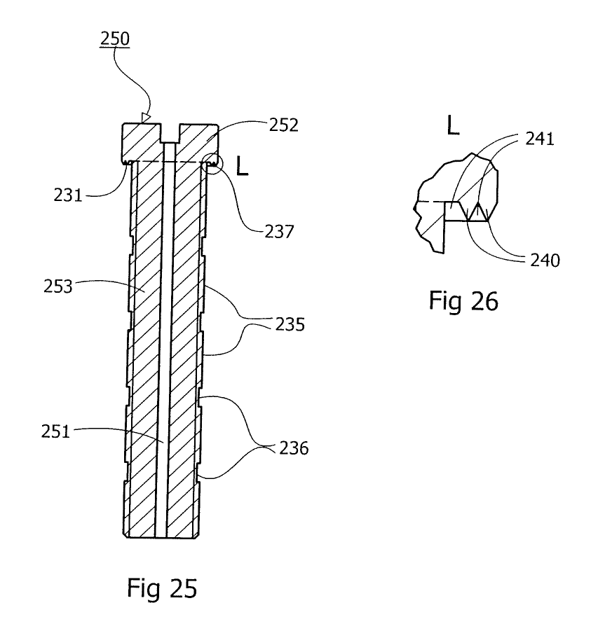

FIG. 23 shows the screw 3 from a side view having a head 230 with an abutment surface 231 and a stem 232 integrally made with the head. The screw head is plane and has a slot 233 for applying a tool for mounting. The stem is threaded and has a longitudinal recess 234 extending along the stem. FIG. 25 shows a screw 250 according to an alternate embodiment, wherein the recess 234 is substituted by a longitudinal through hole 251, provided through the head 252 and the stem 253. The stem 232, 253 has one or several portions 235, and has notches 236 between the portions. It is possible to shorten the stem, for example for adapting the length of the stem to the bore of an implant, by removing one or several portions of the stem, which can be performed by cutting the stem at one of the notches.

The abutment surface 231 of the head 230 is provided with a compressible sealing 237 integrally made with the abutment surface 231 and is made in the same material as the screw, for example a metal, such as titan, or a polymeric material. FIG. 24 shows in enlarged scale that the sealing has protrusions 240 forming grooves 241 therebetween, which are circular, helical or spiral-shaped and are symmetrical arranged at the abutment surface 231. The cross sections of the protrusions are triangular, triangular having a rounded or truncated cone, semi circular, semi elliptical, square or of any other shape. The protrusions are forming an abutment surface that is plane or inclined in relation to the horizontal plane. The protrusions are compressible and are deformed when a force is applied. In an alternate embodiment, for example when choosing a different material, the protrusions are compressible but could be resilient.

As seen in FIGS. 2 and 15, the head 230, 252 of the screw 3, 250 is dimensioned to be arranged into the first passage of the bridge support 1, 60, 90, 140 and is forming a straight line with the top of the bridge support 1, 60, 90 when the abutment surface 231 of said head is abutting the shoulder 34. The first passage of the bridge support 140 according to the fourth embodiment is deeper than the first passage of the bridge supports 1, 60, 90 leaving a part of the first passage free when the abutment surface 231 of the screw 3 is abutting the shoulder 34 of the bridge support 140 at correct arrangement into the bridge support 140 and into the implant 2.

The stem 232 is dimensioned to be arranged into the second passage protruding below the surface 30 of the bridge support 1, 60, 90, 140 for engagement with a threaded bore of the implant 2. The first sealing 31, provided at the surface 30 of the bridge support, is abutting the top of the implant 2 at correct arrangement. When the stem 232, 253 is completely inserted into the bore of the implant 2, the protrusions of the first sealing 31 are compressed, and the protrusions of the second sealing 35 at the shoulder 34 of the bridge support and the first sealing 237 of the screw 3 could cooperate and are compressed. To cooperate involve that the protrusions 50 of the sealing 35 and the protrusions 240 of the sealing 237 interacts, i.e. the protrusions 240 fit into the grooves 51 and the protrusions 50 fit into the grooves 241. The compressions and the cooperation of the sealing 35 and the sealing 237 provide a leak proof connection between the bridge support and the screw, and the compression of the sealing 31 provide a leak proof connection between the bridge support and the implant 2. Due to the protrusions of each compressible sealing 31, 35, the bridge support 1, 60, 90, 140 is flexible and can be arranged to different types of implants forming leak proof connections between the bridge support and the screw 3, 250, and the bridge support and the implant 2.

As seen in FIG. 15, a space 150 is defined between the bridge support 1 or 140 and the implant 2 and the stem 253, which may be used for application of a germicidal gel.

A method for mounting the bridge support 1, 60, 90, 140 to an implant 2 by using a screw 3, 250 starts by the step of arranging the bridge support on the implant in such way that the surface 30 of the bridge support, provided with the first compressible sealing 31, is abutting the implant, and the channel 32 of the bridge support is arranged over the bore of the implant. Then follows the step of inserting the screw 3, 250 into said channel, in such way that the abutment surface 231 of the screw is abutting the shoulder 34 of the channel 33, and into said bore. Thereafter follows the step of fastening the bridge support to the implant by screwing the screw while the sealing 237 of the screw 3, 250 is cooperating with the second sealing 35 of the bridge support during compression of each sealing 35, 237 and until the first sealing 31 of the bridge support is compressed against the implant.

Currently used screws have a dimension of the stem 232, 253 that is smaller than the corresponding dimension of the bore of the implant. This difference in dimensions provides a radial play that is necessary to make it possible to discharge fluid collected into the bore and to overcome the pressure from the fluid against the screw 3, 250, which is required for correctly mounting of the implant. The recess 234 of the screw 3 or the through hole 251 of the screw 250 makes it possible to use a dimension of the screw 3, 250 that corresponds with the dimension of the bore of the implant 2. The recess 234 enables saliva, blood, water and other fluids to be discharged from the bore of the implant. A dimension of the screw corresponding with the dimension of the bore of the implant, without a radial play, provides a more stable and stiffer construction of the bridge support and the implant, which promotes the healing up of the implant to the bone tissue. In an alternate embodiment the bore of the implant may be provided with a longitudinal recess, to make it possible to discharge fluids from the bore, when the dimension of the screw corresponds with the dimension of the bore of the implant.

A method for discharging fluid from a bore of an implant for mounting a bridge, provided with a surface with a first compressible sealing and a through channel having a shoulder with a second compressible sealing, to the implant by using a screw, has the steps of providing a screw 3 with a stem provided with an external longitudinal recess or a screw 250 with a stem having a through hole 251; arranging the bridge support on the implant in such way that the surface having the sealing is abutting the implant, and that the through channel of the bridge support is arranged over the bore; inserting the screw into said channel and into the bore; and fastening the bridge support to the implant by screwing the screw while fluid is discharged from the bore through the recess 234 or through the through hole 253, and until the first sealing of the bridge support is compressed against the implant. To further improve the leak proof function of the arrangement of a bridge support fasten to an implant by a screw, it could be possible to arrange a sealing having protrusions on a surface of the implant abutting the bridge support.

In the claims, the term “comprises/comprising” does not exclude the presence of other elements or steps. Furthermore, although individually listed, a plurality of means, elements or method steps may be implemented. Additionally, although individual features may be included in different embodiments, these may possibly be combined in other ways, and the inclusion in different embodiments does not imply that a combination of features is not feasible. In addition, singular references do not exclude a plurality. The terms “a”, “an” does not preclude a plurality. Reference signs in the claims are provided merely as a clarifying example and shall not be construed as limiting the scope of the claims in any way.

1. A bridge support (1, 60, 90, 140) for arrangement to a dental implant (2), provided with a bore, has a surface (30) abutting the implant (2) and an outside (160), characterized in that it has a first compressible sealing (31) integrally made with said surface (30).

2. The bridge support (1, 60, 90, 140) according to claim 1, characterized in that it has a through channel (33) ending at said surface (30) and is shaped in such way that a shoulder (34) is formed inside said channel (33), and in that a second sealing (35) is integrally made with said shoulder (34).

3. The bridge support (1, 60, 90, 140) according to claim 1 and/or 2, characterized in that each sealing (31, 35) is made of the same material as the bridge support (1, 60, 90, 140).

4. The bridge support (1, 60, 90, 140) according to claim 3, characterized in that the material is a metal, or a ceramic material.

5. The bridge support (1, 60, 90, 140) according to any of the preceding claims, characterized in that each sealing (31, 35) has protrusions (40, 50) forming grooves (41, 51) therebetween.

6. The bridge support (1, 60, 90, 140) according to claim 5, characterized in that the protrusions (40, 50) are circular, helical or spiral-shaped.

7. The bridge support (1, 60, 90, 140) according to claim 5 or 6, characterized in that the protrusions (40, 50) are forming an abutment surface (42) that is plane or inclined in relation to the horizontal plane.

8. The bridge support (140) according to any of the preceding claims, characterized in that it has external protrusions integrally made with the outside (160).

9. The bridge support (140) according to claim 8, characterized in that the external protrusions are made in the same material as the bridge support (140).

10. The bridge support (1, 60, 90, 140) according to claim 8 and/or 9, characterized in that the external protrusions are circumferentially arranged.

11. A screw (3, 250) for fastening a bridge support (1, 60, 90, 140) to a dental implant (2), provided with a bore, has a head (230, 252) with an abutment surface (231) and a stem (232, 253), characterized in that it has a compressible sealing (237) integrally made with said abutment surface (231).

12. The screw (3, 250) according to claim 11, characterized in that said sealing (237) is made of the same material as the screw (3, 250).

13. The screw (3, 250) according to claim 12, characterized in that the material is a metal or a polymer

14. The screw (3, 250) according to any of the claims 11-13, characterized in that said sealing has protrusions (240) forming grooves (241) therebetween.

15. The screw (3, 250) according to claim 14, characterized in that the protrusions (240) are circular, helical or spiral-shaped.

16. The screw (3, 250) according to claim 14 and/or 15, characterized in that the protrusions (240) are forming an abutment surface (231) that is plane or inclined in relation to the horizontal plane.

17. The screw (3, 250) according to the claims 11-16, characterized in that the stem (232, 253) comprises one or several portions (235) having notches (236) therebetween, wherein the portions (235) are separable at the notches (236).

18. The screw (3) according to any of the claims 11-17, characterized in that the stem (232) has an external longitudinal recess (234).

19. The screw (250) according to any of the claims 11-17, characterized in that the stem (253) has an external longitudinal through hole (251).

20. A method for fastening a bridge support (1, 60, 90, 140) having a surface (30), provided with a first compressible sealing (31), and a through channel (33) having a shoulder (34), provided with a second compressible sealing (35), by using a screw (3, 250) having an abutment surface (230), provided with at least one compressible sealing (231), on an implant (2), provided with a bore, wherein
the bridge support (1, 60, 90, 140) is arranged on the implant (2) in such way that the surface (30) of the bridge support (1, 60, 90, 140) provided with the first sealing (31) is abutting the implant (2), and that the channel (33) of the bridge support (1, 60, 90, 140) is arranged over the bore,
the screw (3, 250) is inserted into said channel (33), in such way that the abutment surface (230) of the screw (3, 250) is abutting the shoulder (34) of the channel (33), and into said bore, and
the bridge support (1, 60, 90, 140) is fastened to the implant (2) by screwing the screw (3, 250) while the sealing (237) of the screw (3, 250) is cooperating with the second sealing (35) of the bridge support (1, 60, 90, 140) during compression of each sealing (35, 237), and until the first sealing (31) of the bridge support (1, 60, 90, 140) is compressed against the implant (2).

21. A method for discharging fluid from a bore of an implant (2) for mounting a bridge support (1, 60, 90, 140) provided with a surface (39) with a first compressible sealing (31) and a through channel (33) having a shoulder (34) with a second compressible sealing (35), to the implant (2) by using a screw (3), wherein
a screw (3) having a stem (232) provided with an external longitudinal recess (234) is provided,
the bridge support (1, 60, 90, 140) is arranged on the implant (2) in such way that the surface (30) with the sealing (31) is abutting the implant (2), and that the through channel (33) of the bridge support (1, 60, 90, 140) is arranged over the bore,
the screw (3) is inserted into said channel (33) and into the bore, and
the bridge support (1, 60, 90, 140) is fastened to the implant (2) by screwing the screw (3) while fluid is discharged from the bore through the recess (234), and until the first sealing (31) of the bridge support (1, 60, 90, 140) is compressed against the implant (2).

22. A method for discharging fluid from a bore of an implant (2) for mounting a bridge support (1, 60, 90, 140) provided with a surface (39) with a first compressible sealing (31) and a through channel (33) having a shoulder (34) with a second compressible sealing (35), to the implant (2) by using a screw (250), wherein
a screw (250) having a stem (232) provided with an longitudinal through hole (251) is provided,
the bridge support (1, 60, 90, 140) is arranged on the implant (2) in such way that the surface (30) with the sealing (31) is abutting the implant (2), and that the through channel (33) of the bridge support (1, 60, 90, 140) is arranged over the bore,
the screw (250) is inserted into said channel (33) and into the bore, and
the bridge support (1, 60, 90, 140) is fastened to the implant (2) by screwing the screw (250) while fluid is discharged from the bore through the longitudinal through hole (251), and until the first sealing (31) of the bridge support (1, 60, 90, 140) is compressed against the implant (2).
